(19) United States
(12) Patent Application Publication
(10) Pub. No.: US 2025/0012666 A1
(43) Pub. Date: Jan. 9, 2025

(54) DRIVE MODULE FOR A DRIVE TRAIN TEST STAND, DRIVE TRAIN TEST STAND AND METHOD FOR PRODUCING THE DRIVE MODULE

(71) Applicant: ZF Friedrichshafen AG, Friedrichshafen (DE)

(72) Inventor: Christian Hell, Untergriesbach (DE)

(73) Assignee: ZF Friedrichshafen AG, Friedrichshafen (DE)

(21) Appl. No.: 18/712,938

(22) PCT Filed: Nov. 23, 2022
(86) PCT No.: PCT/EP2022/082937

§ 371 Date: May 23, 2024

(30) Foreign Application Priority Data
Nov. 25, 2021 (DE) 10 2021 213 284.7

(51) Int. Cl. G01M 13/025

(52) U.S. Cl. CPC G01M 13/025

(57) ABSTRACT

A drive module (10) for a drive train test stand includes an electric motor (12) and a base frame (11), wherein the base frame (11) carries the electric motor (12). The drive module (10) according to the invention is characterized in that the drive module (10) encloses a housing (13) of the electric motor (12) circumferentially along a circumferential direction of the housing (12) to 360°. The invention further relates to a corresponding drive train test stand and to a method for producing the drive module.

### RELATED APPLICATIONS

This application claims the benefit under 35 U.S.C. § 371 as a U.S. National Phase Application of application no. PCT/EP2022/082937, filed on 23 Nov. 2022, which claims the benefit of German Patent Application no. 10 2021 213 284.7 filed on 25 Nov. 2021, the contents of which are hereby incorporated herein by reference in their entireties.

### FIELD OF THE DISCLOSURE

The invention relates to a drive module for a drive train test stand for testing electric motor vehicle drive trains, to a corresponding drive train test stand for testing electric motor vehicle drive trains, and to a method for producing the drive module.

### BACKGROUND

Transmission test stands or drive train test stands for testing motor vehicle transmissions or entire motor vehicle drive trains are known from the prior art. In addition to test stands of this type for testing combustion-powered drive trains, test stands for testing electric motor vehicle drive trains are becoming increasingly prevalent in the prior art, the construction of which test stands differs in various ways from the test stands for combustion-powered drive trains. In particular, an electric motor vehicle drive train must be configured for significantly greater input speeds, for example, which presents specific challenges in terms of the noise behavior at very high speeds and, in particular, the vibration damping. A drive train test stand for an electric motor vehicle drive train must therefore be able to provide high speeds and moreover have a drive unit with which only minimal mechanical vibrations are generated or introduced into the component under test, even at high and very high speeds.

In this regard, DE 10 2016 224 138 A1 describes an electric motor for a drive unit of an electric drive train test stand, in which the housing may be supported via a mechanical front yoke and a mechanical rear yoke. The yoke arms extend radially sideways, starting from the upper region of the housing, so that there are clearances below and at the side of the motor through which, for example, output shafts of a component under test may be guided past the electric motor. The front yoke here is formed in one piece with a front-end shield of the electric motor and the rear yoke is formed in one piece with a rear-end shield. Since the bearings of the motor shaft are therefore connected to the electric motor mount in a very secure and rigid manner, the occurrence of vibrations may be substantially avoided, in particular even at the very high motor speeds required for testing electric motor vehicle drive trains.

A test stand having a base frame on which a test stand drive is arranged is known from DE 10 2019 216 750 A1. A test shaft of the test stand drive can be connected coaxially to a bearing shaft of a bearing unit, which bearing shaft is mounted to rotate about the axis of rotation. The bearing unit is in turn releasably arranged in a recess of a bearing housing securely connected to the base frame, which recess is coaxial to the axis of rotation. The coaxial recess here is a recess which is symmetrical with respect to the axis rotation and is in the shape of a cone portion.

### SUMMARY

However, the known drive modules for drive train test stands are disadvantageous in that, particularly at increasingly high speeds, a greater rigidity and vibration-damping capacity of the drive module are desirable in order to be able to ensure the required properties in terms of the machine dynamics. Moreover, it is desirable if the electric motor of the drive module can be replaced easily, without time-consuming and complex realignment.

An object of the present invention is to propose an improved drive module for a drive train test stand for testing electric motor vehicle drive trains.

This object is achieved according to the invention by the drive module for a drive train test stand for testing electric motor vehicle drive trains according to the present disclosure. Advantageous configurations will be apparent in light of the present disclosure.

The invention relates to a drive module for a drive train test stand, wherein the drive module comprises an electric motor and a base frame and wherein the base frame carries the electric motor. The drive module according to the invention is notable in that the drive module encloses a housing of the electric motor circumferentially to 360° along a circumferential direction of the housing.

The invention therefore describes a drive module for a drive train test stand, wherein the drive train test stand is designed for testing motor vehicle drive trains, in particular electric motor vehicle drive trains. The component to be tested is therefore preferably an electric motor vehicle drive train. Electric motor vehicle drive trains differ from conventionally driven motor vehicle drive trains in particular owing to the very much higher input speed, which in turn presents comparatively greater challenges in terms of the vibration damping or rigidity of the motor vehicle drive train and in terms of the noise behavior of the motor vehicle drive train.

In addition to the drive module, the drive train test stand preferably also has a holder for holding the component under test and possibly one or more output modules, which may generate an adjustable load on the component under test with respect to the drive module.

The drive module in turn comprises an electric motor, wherein the electric motor may apply an input speed and an input torque to the component under test, subject to the activation of the electric motor.

It is preferably provided that the electric motor is designed to reach speeds of up to 25000 rpm, particularly preferably up to 30000 rpm and especially preferably up to 35000 rpm. Such speeds correspond to the speeds which the electric drive, i.e., the electric motor, of the electric motor vehicle drive currently generates, or will generate, during its operation. This enables realistic testing of the motor vehicle drive.

Furthermore, the drive module comprises a base frame which carries the electric motor, i.e., the electric motor is arranged on or in the base frame.

To this end, the drive module or the base frame advantageously has a motor mount, which generally corresponds to the cylindrical form of the housing in a congruent manner. That is to say, in the case of a cylindrical housing of the electric motor, the motor mount is designed as a cylindrical opening which corresponds to the housing in terms of its length and diameter.

The advantage of this is that the electric motor may be arranged in the base frame without play over its entire 360° circumference and may be brought into contact with the motor mount in the base frame. This therefore results in a high level of rigidity and, in terms of the machine dynamics, a very robust connection to the base frame so that, comparatively, the drive module has a very high structural resonant frequency, whereby the occurrence of mechanical vibrations may in turn be effectively prevented.

Although it is provided according to the invention that the base frame encloses the housing via the motor mount along its entire circumference, i.e., over 360°, the motor mount does not necessarily also have to simultaneously be in contact with the housing over the entire axial length of the housing. Instead, it is advantageously provided that the motor mount only abuts against the housing over the entire extent in the region of a front bearing of the motor shaft and in the region of a rear bearing of the motor shaft. Since the vibrations of the motor shaft are transferred to the housing in the region of the bearings of the motor shaft, they may also be particularly effectively reduced owing to the rigid connection according to the invention at precisely these points. Moreover, the production of the motor mount is simplified if it only abuts against the housing in two axial regions, since the motor mount must be produced with particularly low tolerances in all regions in which it is in contact with the housing.

The front-end shield of the housing advantageously holds a front bearing of the motor shaft, and the rear-end shield of the housing advantageously holds a rear bearing of the motor shaft. The motor shaft is therefore supported on the front-end or rear-end shield via the front or rear bearing.

In the motor mount, the electric motor may be secured against twisting in that it either abuts against the motor mount with friction fit, for example, or in that a longitudinal groove is provided, for example, in which the electric motor may engage with form fit and may therefore be supported radially.

A stop is preferably also provided in the motor mount, which stop delimits or fixes an axial position of the electric motor in the motor mount.

It is preferably provided that, owing to the design according to the invention, the drive module has a first natural frequency above the first order of rotation of the electric motor. At a motor speed of 30,000 rpm, the natural frequency of the drive module is therefore above ca. 500 Hz. This has proven particularly suitable for testing high-speed electric motor vehicle drive trains.

According to a preferred embodiment of the invention, it is provided that the housing has a conical form, and the base frame has a conical motor mount via which the electric motor can be arranged in the base frame.

Within the context of the invention, a conical housing is not understood to mean that, geometrically speaking, the housing necessarily represents an entire cone, but rather that the housing represents at least an axial cone portion, whereof the cone tip is generally missing.

For example, the housing comprises a sheath-like body, which, geometrically speaking, corresponds to a cone portion. However, instead of a cone tip, the housing has a front-end shield, whereof the diameter is smaller than the diameter of the rear-end shield.

This therefore means that the housing of the electric motor advantageously deviates from the cylindrical form conventional in electric motors in that it has a first end shield with a smaller diameter and a second end shield with a larger diameter.

In this case, the base frame preferably has a motor mount which corresponds to the conical form of the housing in a congruent manner. For example, the electric motor may be inserted into the motor mount through the axial end of the motor mount with the larger diameter by its first axial end (which has the smaller diameter) until it reaches a stop, and it may be secured in the motor mount.

In this case, the stop may advantageously be generated by the housing of the electric motor coming into contact with the inner side of the motor mount. Since the diameter of the housing increases with its axial length, further insertion of the electric motor into the motor mount is then impossible.

The advantage is furthermore realized that, owing to the conical housing form, which may be brought into contact with the conical motor mount, very high positional accuracy of the electric motor, and therefore a shaft of the electric motor, may be achieved. In particular, this dispenses with complex alignment of the electric motor in the motor mount via so-called seating strips, as is conventional in generic drive modules of the prior art, in particular those with a foot connection.

According to a preferred embodiment of the invention, it is provided that the motor mount is designed as a bore. The design as a bore enables simple producibility of the motor mount on the one hand and very precise manufacture on the other hand. Precise manufacture is advantageously required since it is difficult to align the electric motor in the motor mount without additional effort. Any deviation from the optimum alignment of the electric motor or the motor shaft of the electric motor from the component under test leads to the generation of vibrations since such deviations-even if slight—have to be compensated via self-aligning couplings, which, depending on their deflection, in turn generate resetting forces which may consequently cause vibrations.

According to a particularly preferred embodiment of the invention, it is provided that a cone angle of the motor mount and of the housing is between 1° and 5° in each case. The cone angle is preferably between 1° and 3°, in particular 2°. This not only results in an exact coaxial alignment of the electric motor in the motor mount, but also in good introduction of the bearing forces into the motor mount.

According to a further preferred embodiment of the invention, it is provided that an outer side of the housing abuts against an inner side of the motor mount. Since the outer side of the housing of the electric motor, i.e., in particular the entire lateral surface of the housing, abuts against the inner side of the motor mount, there is a maximum surface contact between the electric motor and the base frame and therefore maximum rigidity of the connection. The occurrence of vibrations may therefore be optimally avoided to the greatest possible extent.

Since, with the same axial length, a conical housing form moreover has a greater lateral surface than a cylindrical housing form, the electric motor in this case may be in contact with the base frame over a comparatively larger contact surface, which therefore improves the rigidity of the connection of the electric motor to the base frame.

According to an alternative preferred embodiment of the invention, it is provided that the motor mount comprises at least two bearing rings via which the electric motor can be arranged in the base frame. In this case, the electric motor does not come into contact with the base frame over the entire lateral surface of its housing; instead, the contact surfaces are restricted to those regions of the housing which are in contact with the at least two bearing rings. Therefore, although the rigidity of the connection is reduced compared to when the lateral surface contacts the base frame over its entire lateral surface, a comparatively more precise alignment of the electric motor, in particular in relation to an output shaft to be coupled to the motor shaft, may be achieved in a simple manner via the bearing rings. The alignment and fixed arrangement of the bearing rings is generally more simple than the precise installation of a bore as a motor mount here.

In the case of a conical design of the housing of the electric motor, an inner contact surface of the bearing rings which can be brought into contact with the housing is advantageously designed as a surface of a cone portion so that the inner contact surfaces each abut entirely against the housing when the electric motor is accommodated in the motor mount.

According to a particularly preferred embodiment of the invention, it is provided that the at least two bearing rings are designed to enable the measurement of a force and/or a torque which acts between the housing and the motor mount. Since the bearing rings preferably hold the electric motor, in particular enclose it radially, a torque acting on the housing of the electric motor or a force acting on the housing of the electric motor may therefore be detected comparatively accurately and without an additional spatial requirement. Since the torque acting on the housing is identical to the torque output via the motor shaft, the torque output to the drive train test stand by the electric motor may be ascertained as exactly as possible. Compared to measuring flanges which are conventionally arranged in the drive train to measure the torque, the advantage is realized that additional installation space in the drive train is not needed. Moreover, by dispensing with the measuring flange, an additional mass, which would also cause vibrations in the event of only a minimal imbalance, is also not incorporated in the drive train.

According to a further preferred embodiment of the invention, it is provided that the housing is held in the motor mount via a clamping ring at its axial end with the greater diameter. The clamping ring here may close the motor mount axially behind the electric motor inserted into the motor mount, for example, so that the electric motor is axially secured.

The clamping ring preferably has at least one draw-off thread via which the clamping ring may be removed from the motor mount again in a simple manner. Via the at least one draw-off thread, a draw-off device may be screwed into the clamping ring on a front side, for example, until it projects out of the clamping ring on a rear side and therefore forces the clamping ring out of the motor mount.

The clamping ring may abut against the housing of the electric motor with friction fit, for example, or it may be connected to the housing in a rotationally fixed manner via a form-fitting connection, for example, so that the electric motor is secured axially as well as radially by the clamping ring. In particular, in the case of a form-fitting connection, for example via a screw thread, the electric motor may moreover be removed from the motor mount together with the clamping ring via the release thread of the clamping ring.

Furthermore, the clamping ring may preferably be connected to the motor mount with friction fit or it may be connected to the motor mount in an axially fixed or rotationally fixed manner via a form-fitting connection, for example, so that the clamping ring may also support, at the motor mount, in particular torques from the electric motor acting on the clamping ring.

The clamping ring and the housing of the electric motor may particularly preferably also be formed in one piece. In this case, it may possibly be necessary to align the electric motor in the motor mount via seating strips or seating rings.

According to a further preferred embodiment of the invention, it is provided that the base frame is designed as a vibration-damping body. For example, the base frame may be made entirely or partially of mineral concrete, polymer concrete or a similar vibration-damping material.

The base frame preferably moreover has a metal framework, which is surrounded, in particular encapsulated, by the vibration-damping material.

According to a further preferred embodiment of the invention, it is provided that the drive module furthermore comprises a device for supplying electric power. A device of this type may be, in particular, a so-called terminal box, which is conventionally mounted on or in the drive module. The device here accommodates the external lines needed for the electrical supply to the electric motor and to activate the electric motor and transmits the electric power and the signals for activating the electric motor-possibly in modified form—to the electric motor.

Furthermore, the device may comprise power electronics elements in its interior. The power electronics elements may be powerful semiconductor switching elements, for example, which together form an inverter for activating the electric motor. In particular, a single-phase alternating current supply or a direct current supply may therefore be converted into a three-phase current for the electric motor.

Therefore, the electric supply lines do not lead to the electric motor directly, but rather via the device. To this end, the device advantageously comprises, in its interior, a series of electrical contacts, the so-called strip terminals, via which the individual coils of the electric motor may be powered.

According to a particularly preferred embodiment of the invention, it is provided that the base frame has a slot which extends from an opening of the motor mount and along the motor mount and which opens the motor mount towards an outer side of the base frame. This slot advantageously enables electrical contacting of the electric motor, which is preferably realized by metal pins, in particular three metal pins, and is accessible from outside the base frame via the slot. Each pin here is associated with a coil of the electric motor.

The slot is preferably incorporated in a top side of the base frame and therefore opens the motor mount accordingly upwards. When the electric motor is therefore inserted into the motor mount, it may be aligned with the three pins directed upwards. The pins then project at least into the slot or also out of the slot at the top, depending on their length. In each case, however, the pins are accessible through the slot for electrical contacting.

The structure of the base frame, and therefore its rigidity and its capacity for vibration damping, are only minimally impaired through the provision of the slot.

According to a further particularly preferred embodiment of the invention, it is provided that the device is arranged on a top side of the base frame. The device is therefore arranged comparatively near to the electric motor and may, in particular, contact the three pins, which preferably represent the electrical contacts of the electric motor, directly through the slot.

The device is particularly preferably fastened on the top side by means of a plurality of screw connections or clamping connections. Both options enable comparatively rigid fastening.

According to a further particularly preferred embodiment of the invention, it is provided that a reinforcing strut is arranged on the base frame, adjacently to the opening of the motor mount. The reinforcing strut is, in particular, arranged transversely to the slot and connects opposite sides of the slot in the region of the opening of the motor mount. The advantage of this is that, in the region of the slot, which, in principle, brings about a reduction in the rigidity, good rigidity may still be ensured via the reinforcing strut.

The rigidity of the drive module may be advantageously maintained, or even increased, via the reinforcing strut to the extent that vibrations generated by the electric motor do not meet the natural frequency of the drive module, i.e., in particular resonance effects do not occur. It is therefore advantageously achieved that the actually negative effects of the slot in terms of the machine dynamics can be at least compensated by the provision of the reinforcing strut.

The reinforcing strut is preferably made of solid steel or mineral concrete or polymer concrete.

One or more reinforcing struts may advantageously also be provided directly in or on the device for supplying electric power or in or on the terminal box.

According to a further preferred embodiment of the invention, it is provided that the drive module furthermore comprises an output shaft, which is mounted coaxially to a motor shaft of the electric motor and can be coupled to the motor shaft in a rotationally fixed manner via its first axial end and can be coupled to a component under test in a rotationally fixed manner via its second axial end. The output shaft here may be advantageously coupled to the motor shaft of the electric motor and to the component under test via a flanged connection in each case. Alternatively, preferably, the output shaft may also be coupled to the motor shaft or to the component under test via a self-aligning coupling, wherein the self-aligning coupling enables the compensation of slight radial offsets between the output shaft and the motor shaft or between the output shaft and the component under test.

The output shaft is advantageously radially mounted over a further part of its axial length so as to ensure the greatest rigidity possible in the region of the output shaft.

The invention furthermore relates to a drive train test stand for testing electric motor vehicle drive trains, comprising a drive module according to the invention. Therefore, the advantages mentioned in connection with the drive unit according to the invention are also realized for the drive train test stand according to the invention.

Finally, the invention also relates to a method for producing a drive module according to the invention for a drive train test stand. The method according to the invention is notable in that a metal framework of the base frame is produced in a first step and the metal framework is encapsulated in a mineral cast in a second step. The metal framework here already specifies the final form of the base frame, at least in terms of its outline. Moreover, it supports the mineral cast in which the framework is encapsulated in the second step. The mineral cast has a comparatively high vibration-damping capacity and is particularly rigid. Owing to the high level of rigidity of the mineral cast, the elastic properties, and therefore disadvantageous properties of the metal framework in terms of vibrations, may also be compensated.

A highly rigid base frame for the drive module according to the invention may therefore be produced in a simple and cost-effective manner.

According to a preferred embodiment of the invention, it is provided that, during the second step, a motor mount is generated in the base frame by positioning a placeholder, which corresponds to an outer form of a housing of an electric motor of the drive module, in the mineral cast. The placeholder here may be cylindrical or conical, depending on the housing form for which the motor mount is to be designed. The placeholder may be aligned and positioned with respect to the metal framework before the encapsulation, for example. This represents a simple as well as quick and cost-effective option for precise production of the motor mount. A comparatively complex production process for the motor mount, for example by drilling, is therefore advantageously omitted.

According to a further preferred embodiment of the invention, it is provided that the mineral cast is shrink-proof. The advantage of this is that the motor mount maintains the form originally defined by the placeholder during the hardening of the mineral cast. Mechanical stresses between the motor mount and the placeholder do not occur and the motor mount does become narrower during the hardening process.

### BRIEF DESCRIPTION OF THE DRAWINGS

The invention is explained by way of example below, with reference to embodiments illustrated in the figures, in which:

FIG. 1 shows, by way of example and schematically in two different views, an embodiment of a drive module which is known in the prior art;

FIG. 2 shows, by way of example and schematically, a drive module according to the invention;

FIG. 3 shows, by way of example and schematically, a partial section through a possible embodiment of a drive module according to the invention; and

FIG. 4 shows, by way of example and schematically, a partial section through a further possible embodiment of a drive module according to the invention.

### DETAILED DESCRIPTION

Identical subject matters, functional units and comparable components are denoted by the same reference signs across all figures. These subject matters, functional units and comparable components are designed to be identical in terms of their technical features unless the description explicitly or implicitly reveals otherwise.

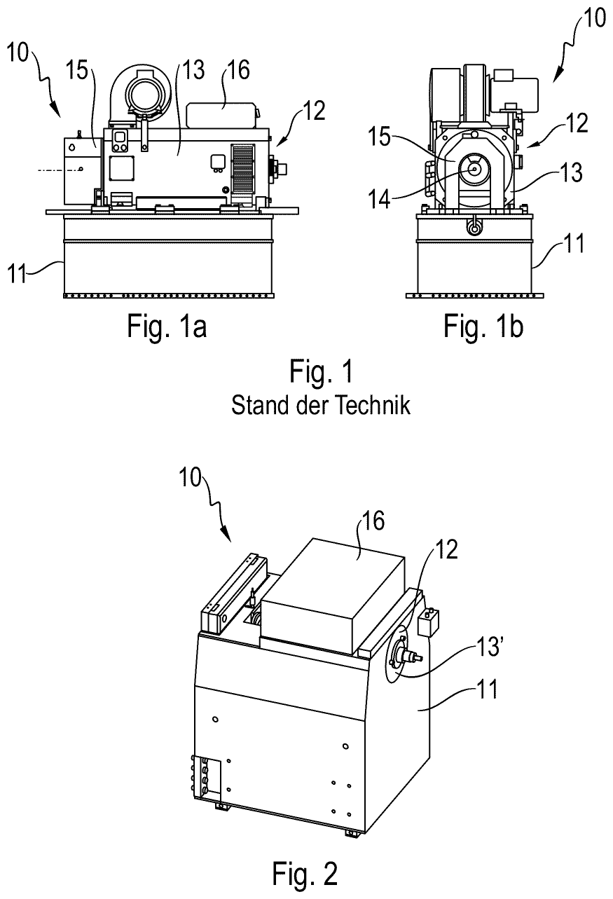

FIG. 1a and FIG. 1b show, by way of example and schematically in two different views, an embodiment (known in the prior art) of a drive module 10 for a drive train test stand (not illustrated in FIG. 1), which is suitable for testing a motor vehicle drive train. The drive module 10 comprises a base frame 11 and an electric motor 12 having a housing 13, which is arranged on the base frame 11 and is carried by the base frame 11. Furthermore, the known drive module 10 comprises an output shaft 14, which is drivingly connected to a motor shaft (not illustrated) of the electric motor 12 and is surrounded by a cover 15. A terminal box 16 is arranged on the electric motor 12. As can be seen, the housing 13 of the electric motor 12 only rests with one side on the base frame 11. The electric motor 12 therefore tends to vibrate during operation of the known drive module 10.

FIG. 2 shows, by way of example and schematically, a drive module 10 according to the invention, comprising an electric motor 12, a base frame 11, a terminal box 16 and an output shaft 14 (concealed by an outer shell of the base frame 11 in FIG. 2).

As can be seen, the electric motor 12 is entirely enclosed by the base frame 11, so that only a rear-end shield 13′ of the electric motor 12 can be seen. A housing 13 of the electric motor 12 has a conical housing form here and is arranged completely within a likewise conical motor mount 18 of the base frame 11. Owing to this complete 360° enclosure in the circumferential direction, the advantage over the known drive modules 10 is realized in that the connection of the electric motor 12 to the base frame 11 is comparatively more rigid and secure, whereby advantages in terms of the machine dynamics are realized.

The base frame 11 is made, for example, of a metal framework, which is encapsulated in mineral concrete.

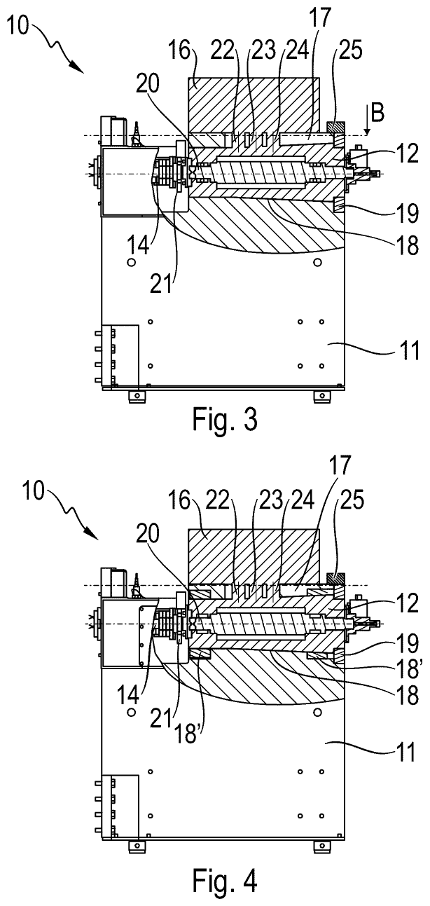

FIG. 3 shows, by way of example and schematically, a partial section through a possible embodiment of a drive module 10 according to the invention. As can be seen, the housing 13 of the electric motor 12 has a conical form and is in contact with an inner surface of the motor mount 18 over its entire lateral surface, which motor mount has been generated during a casting procedure, for example. The cone angle of the motor mount 18 and the housing 13 is, for example, 3° in each case. Only in the region of the slot 17 is the lateral surface of the housing 13 not in contact with the motor mount 18, since pins 22, 23 and 24 of the electric motor 12 can be contacted by the terminal box 16 here to activate the electric motor 12 or to supply electric power to the electric motor 12. The pins 22, 23 and 24 represent the electrical contacts of the electric motor 12. To increase the rigidity of the base frame, in particular in the region of the slot 17, a reinforcing strut 25 is arranged directly adjacent to the slot 17 and near to the terminal box 16, which reinforcing strut is made, for example, of steel and has a solid design. The reinforcing strut 25 is screwed to the base frame 11.

A clamping ring 19, which secures the electric motor 12 axially in the motor mount 18, can furthermore be seen. At the axial end of the electric motor 12 which is opposite the clamping ring 19, the motor shaft 20 is coupled to the output shaft 14 via a measuring flange 21.

FIG. 4 shows, by way of example and schematically, a partial section through a further possible embodiment of a drive module 10 according to the invention. The drive module 10 of FIG. 4 differs from the drive module 10 of FIG. 3 in terms of the design of the motor mount 18. According to the exemplary embodiment of FIG. 4, the motor mount 18 namely comprises two bearing rings 18′ and 18″, which hold and support the electric motor 12. The bearing rings 18′, 18″ therefore enclose the housing 13 of the electric motor circumferentially to 360° along a circumferential direction of the housing 13. The housing 13 of the electric motor 12 according to the exemplary embodiment of FIG. 4 is therefore only indirectly in contact with the motor mount 18 via the bearing rings 18′, 18″. As can be seen, the bearing rings 18′, 18″ are arranged in the region of the bearings of the motor shaft 20 in the electric motor 12. Since vibrations which occur during the operation of the electric motor 12 are produced especially at the bearings, the rigidity may be increased locally through the provision of the bearing rings 18′, 18″ in the region of the bearings, which consequently counteracts the occurrence of vibrations. Therefore, a particularly rigid and low-vibration drive module 10 may also be provided according to the exemplary embodiment of FIG. 4.

### LIST OF REFERENCE SIGNS

10 Drive module
11 Base frame
12 Electric motor
13 Housing
13′ End shield
14 Output shaft
15 Cover
16 Device for supplying electric power, terminal box
17 Slot
18 Motor mount
18′, 18 Bearing ring
19 Clamping ring
20 Motor shaft
21 Measuring flange
22, 23, 24 Pins, electrical contacting of the electric motor
25 Reinforcing strut

1. A drive module (10) for a drive train test stand, wherein the drive module (10) comprises:
an electric motor (12) with a housing; and
a base frame (11), wherein the base frame (11) carries the electric motor (12);
wherein the drive module (10) encloses a housing (13) of the electric motor (12) circumferentially to 360° along a circumferential direction of the housing (12).

2. The drive module (10) as claimed in claim 1, wherein the housing (13) has a conical form and the base frame (11) has a conical motor mount (18) via which the electric motor (12) can be arranged in the base frame (11).

2. The drive module (10) as claimed in claim 2, wherein the conical motor mount has a cone angle from 1° to 5°.

4. The drive module (10) as claimed in claim 1, wherein the motor mount (18) is configured as a bore.

5. The drive module (10) as claimed in claim 1, wherein an outer side of the housing (13) abuts against an inner side of the motor mount (18).

6. The drive module (10) as claimed in claim 1, wherein the motor mount (18) comprises at least two bearing rings (18′, 18″) via which the electric motor (12) can be arranged in the base frame (11).

7. The drive module (10) as claimed in claim 6, wherein the at least two bearing rings (18′, 18″) are configured and arranged to enable a measurement of a force and/or a torque which acts between the housing (13) and the motor mount (18).

8. The drive module (10) as claimed in claim 1, wherein the motor mount has a conical geometry and the housing (13) is held in the motor mount (18) via a clamping ring (25) at an end of the conical geometry having a greater diameter.

9. The drive module (10) as claimed in claim 1, wherein the base frame (11) is designed configured as a vibration-damping body.

10. The drive module (10) as claimed in claim 1, wherein the drive module (10) furthermore comprises a device (16) for supplying electric power.

11. The drive module (10) as claimed in claim 10, wherein the base frame (11) has a slot (17) which extends from an opening of the motor mount and along the motor mount (18) and which opens the motor mount towards an outer side of the base frame.

12. The drive module (10) as claimed in claim 10 the device (16) is arranged on a top side of the base frame (11).

13. The drive module (10) as claimed in claim 10, further comprising a reinforcing strut (25) arranged on the base frame (11) and positioned adjacent to the opening of the motor mount (18).

14. The drive module (10) as claimed in claim 1, further comprising an output shaft (14) having a first axial end and a second axial end, the output shaft mounted coaxially to a motor shaft (20) of the electric motor (12) and configured to be coupled to the motor shaft (20) in a rotationally fixed manner via the first axial end and configured to be coupled to a component under test in a rotationally fixed manner via the second axial end.

15. A drive train test stand for testing electric motor vehicle drive trains, comprising the drive module (10) as claimed in claim 1.

16. A method for producing a drive module (10) for a drive train test stand as claimed in claim 1, the method comprising:
producing a metal framework of the base frame (11); and
encapsulating the metal framework in a mineral cast.

17. The method as claimed in claim 16, wherein encapsulating the metal framework includes generating a motor mount (18) in the base frame (11) by positioning a placeholder corresponding to an outer form of the housing (13) of the electric motor (12) in the mineral cast.

18. The method as claimed in claim 17, wherein the mineral cast is shrink-proof.
